(19) United States
(12) Patent Application Publication
(10) Pub. No.: US 2018/0343420 A1
(43) Pub. Date: Nov. 29, 2018

(54) Motorcycle Camera System

(71) Applicant: Anthony Adolph, Oregon City, OR (US)

(72) Inventor: Anthony Adolph, Oregon City, OR (US)

(21) Appl. No.: 15/602,350

(22) Filed: May 23, 2017

(51) Int. Cl. H04N 7/18; B62J 99/00; B62J 11/00; F16M 13/02; H04N 5/232; H04N 5/225

(52) U.S. Cl. CPC H04N 7/181; B62J 99/00; B62J 11/00; B62J 6/005; H04N 5/23293; H04N 5/2252; B62J 2099/0033; F16M 13/02

(57) ABSTRACT

A motorcycle camera system for enhancing vehicle operation safety includes a vehicle that is selectively ridden. The vehicle has a pair of handlebars and an electronic device is releasably coupled to the handlebars. A pair of camera units is provided and each of the camera units is coupled to the vehicle. Each of the camera units is directed rearwardly from the vehicle to capture images of an associated one of a pair of blind spots with respect to the vehicle. Moreover, each of the camera units is in wireless electrical communication with the electronic device. In this way the electronic device displays the images of the blind spots thereby facilitating the driver to safely change lanes.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including information disclosed under 37 CFR 1.97 and 1.98.

The disclosure and prior art relates to camera devices and more particularly pertains to a new camera device for enhancing vehicle operation safety.

### BRIEF SUMMARY OF THE INVENTION

An embodiment of the disclosure meets the needs presented above by generally comprising a vehicle that is selectively ridden. The vehicle has a pair of handlebars and an electronic device is releasably coupled to the handlebars. A pair of camera units is provided and each of the camera units is coupled to the vehicle. Each of the camera units is directed rearwardly from the vehicle to capture images of an associated one of a pair of blind spots with respect to the vehicle. Moreover, each of the camera units is in wireless electrical communication with the electronic device. In this way the electronic device displays the images of the blind spots thereby facilitating the driver to safely change lanes.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a motorcycle camera system according to an embodiment of the disclosure.

FIG. 2 is a perspective view of an embodiment of the disclosure.

FIG. 3 is a right side view of an embodiment of the disclosure.

FIG. 4 is a perspective view of housing of an embodiment of the disclosure.

FIG. 5 is a perspective view of a retaining unit of embodiment of the disclosure. FIG. 6 is a schematic view of an embodiment of the disclosure.

### DETAILED DESCRIPTION OF THE INVENTION

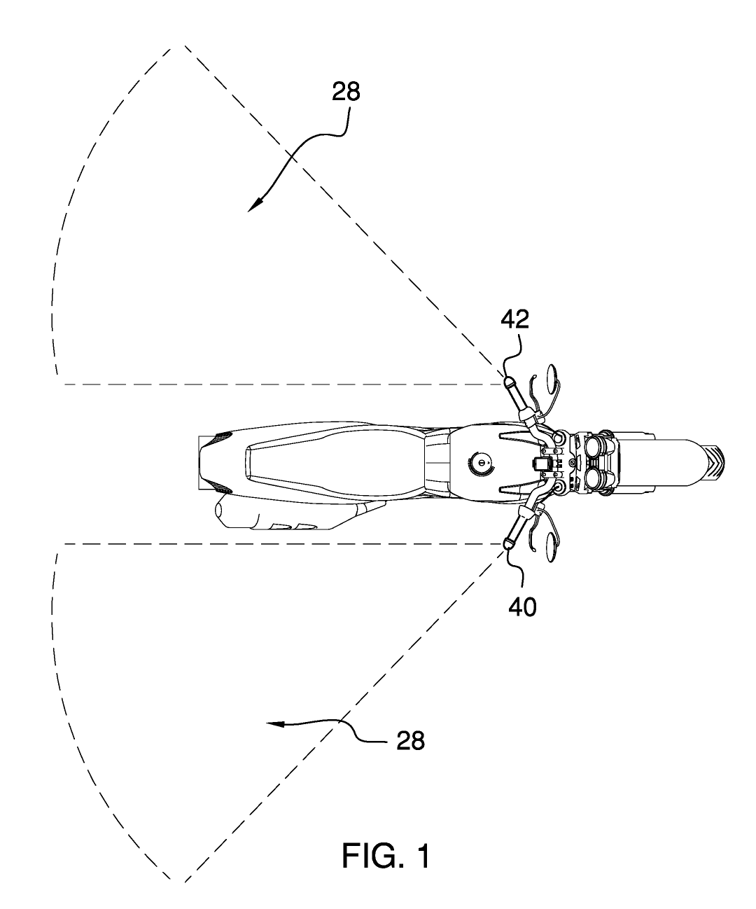

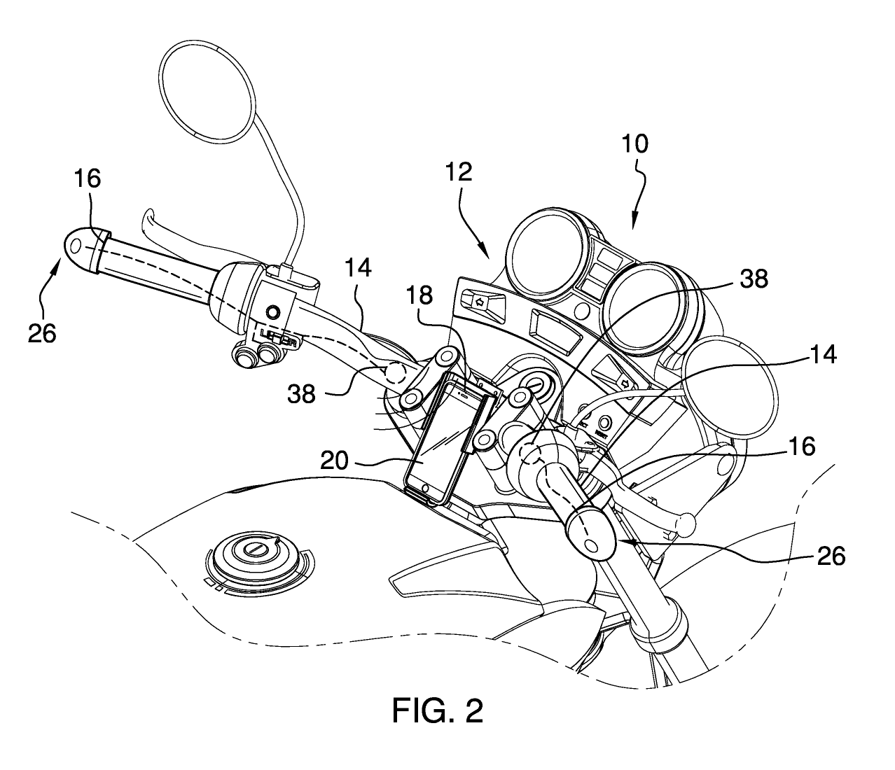

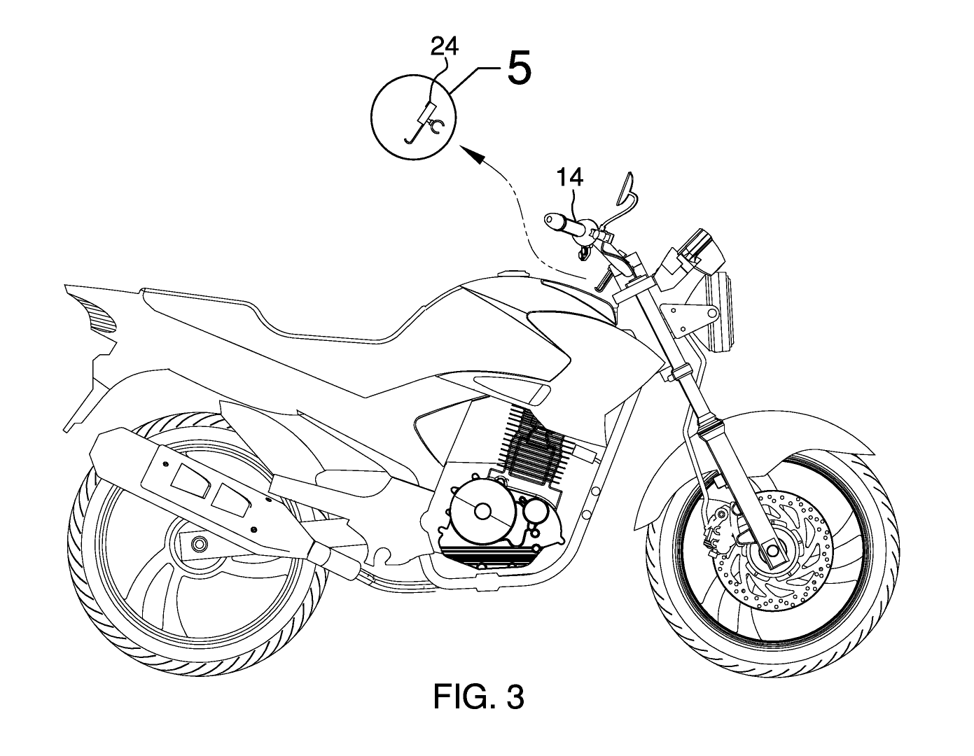

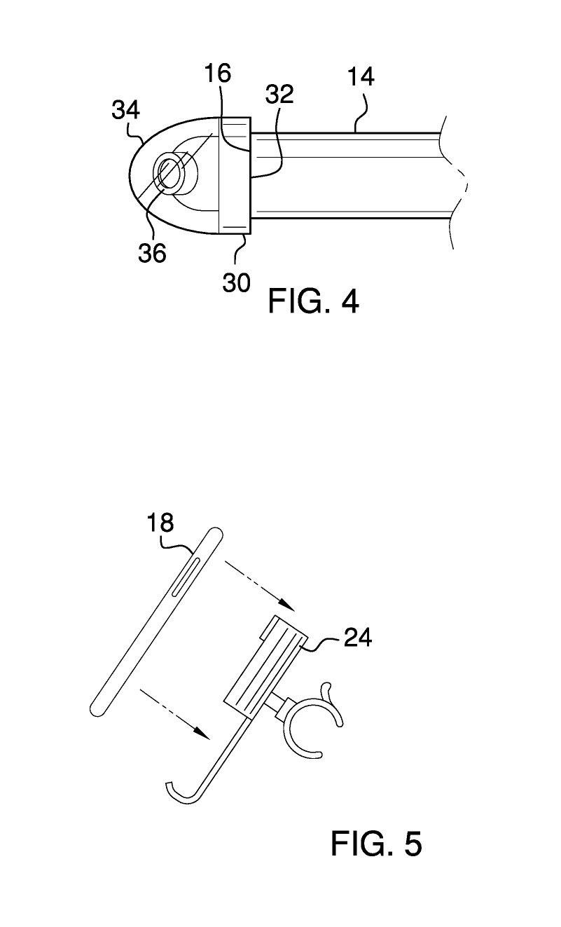

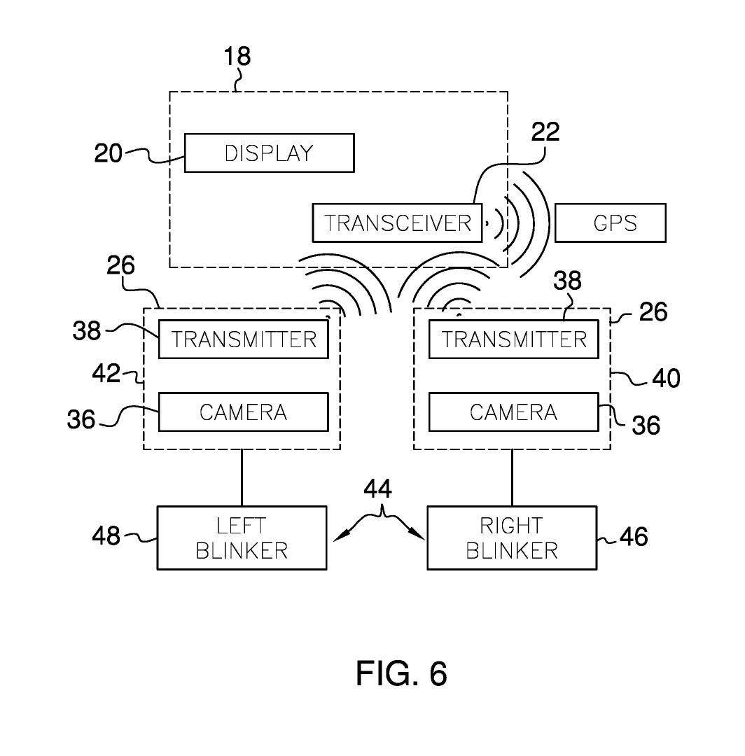

With reference now to the drawings, and in particular to FIGS. 1 through 6 thereof, a new camera device embodying the principles and concepts of an embodiment of the disclosure and generally designated by the reference numeral 10 will be described.

As best illustrated in FIGS. 1 through 6, the motorcycle camera system 10 generally comprises a vehicle 12 that is selectively ridden for transportation purposes. The vehicle 12 has a pair of handlebars 14 and each of the handlebars 14 has a distal end 16 with respect to the vehicle 12. The vehicle 12 may be a motorcycle, a quad or any other vehicle 12 that is legally ridden on a roadway. An electronic device 18 is provided that has a display 20 and a transceiver 22. The transceiver 22 may be a radio frequency transceiver or the like and the transceiver 22 may employ a WPAN signal and Bluetooth communication protocols. The electronic device 18 may be smart phone or the like and the transceiver 22 may be in electrical communication with a global positioning system (gps). In this way the electronic device 18 is capable of determining a speed of the vehicle 12 when the vehicle 12 is driven.

A retaining unit 24 is provided and the retaining unit 24 is removably coupled to the handlebars 14. The retaining unit 24 releasably engages the electronic device 18 such that the display 20 is visible to a driver. Moreover, the retaining unit 24 may be a smart phone mount of any conventional design intended to mount a smart phone or the like to a pair of handlebars 14 or other tubular structure.

A pair of camera units 26 is provided and each of the camera units 26 is coupled to the vehicle 12. Each of the camera units 26 is directed rearwardly from the vehicle 12 to capture images of an associated one of a pair of blind spots 28 with respect to the vehicle 12. Moreover, each of the camera units 26 is in wireless electrical communication with the electronic device 18. In this way the electronic device 18 displays the images of the blind spots 28 thereby facilitating the driver to safely change lanes with respect to other vehicles on a roadway.

The electronic device 18 may store an app or other program that facilitates communication between the electronic device 18 and each of the camera units 26. Each of the camera units 26 may be manufactured as a unitary structure with respect to the handlebars 14. Additionally, each of the camera units 26 may be an aftermarket product with respect to the vehicle 12. Each of the camera units 26 is turned on when the electronic device 18 determines that the vehicle 12 is being driven and that the vehicle 12 has exceeded a trigger speed. The trigger speed may be a speed ranging between approximately 25.0 km/h and 30.0 km/h.

Each of the camera units 26 comprises a housing 30 that has a first wall 32 and a second wall 34. The second wall 34 is concavely arcuate with respect to the first wall 32 such that the housing 30 has a bullet shape. The first wall 32 is coupled to the distal end 16 corresponding to an associated one of the handlebars 14. Each of the camera units 26 includes a camera 36 that is coupled to the second wall 34 of the housing 30. Moreover, the housing 30 is oriented on the associated handlebar 14 to point the camera 36 rearwardly with respect to the vehicle 12. In this way the camera 36 selectively captures the images of the associated blind spot 28. The camera 36 is electrically coupled to the vehicle 12 as a power source and the camera 36 may be a digital video camera or the like.

A transmitter 38 is provided and the transmitter 38 is coupled to the housing 30. The transmitter 38 is electrically coupled to the vehicle 12 as a power source. Additionally, the transmitter 38 is electrically coupled to the camera 36 to receive the images. The transmitter 38 is in electrical communication with the transceiver 22. In this way the transceiver 22 receives the images thereby facilitating the display 20 to display 20 the images. The transmitter 38 may be a radio frequency transmitter 38 or the like and the transmitter 38 may employ a WPAN signal and Bluetooth communication protocols. Additionally, the transmitter 38 may be located within the handlebars 14 or other location that is outside of the housing 30.

The pair of camera units 26 includes a right camera unit 40 and a left camera unit 42. Additionally, each of the camera units 26 is electrically coupled to a blinker system 44 on the vehicle 12. The right camera unit 40 is turned on when a right blinker 46 on the vehicle 12 is turned on. In this way the camera 36 corresponding to the right camera unit 40 captures the images of the blind spot 28 on a right side of the vehicle 12 and the display 20 displays the images of the blind spot 28 on the right side. The left camera unit 42 is turned on when a left blinker 48 on the vehicle 12 is turned on. In this way the camera 36 corresponding to the left camera unit 42 captures images of the blind spot 28 on a left side of the vehicle 12 and the display displays the images of the blind spot 28 on the left side.

In use, the retaining unit 24 is coupled to the handlebars 14 and the electronic device 18 is positioned in the retaining unit 24. The vehicle 12 is started to power the camera 36 and the transmitter 38 corresponding to each of the camera units 26. The electronic device 18 is manipulated to synch the transceiver 22 with the transmitter 38 corresponding to each of the camera units 26.

The vehicle 12 is driven on the roadway and the display 20 is observed when either of the left 48 and right 46 blinkers is turned on and the vehicle 12 is manipulated to change lanes. In this way the corresponding blind spots 28 are visible on the display 20 thereby enhancing safety with respect to changing lanes. Moreover, the display 20 reduces a need for the driver to turn the driver's head in order to look at the corresponding blind spot 28 thereby facilitating the driver to look forward while driving the vehicle 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A motorcycle camera system comprising:
a vehicle being configured to be ridden, said vehicle having a pair of handlebars, each of said handlebars having a distal end with respect to said vehicle;
an electronic device;
a retaining unit being removably coupled to said handlebars, said retaining unit releasably engaging said electronic device such that said display is visible to a driver; and
a pair of camera units, each of said camera units being coupled to said vehicle, each of said camera units being directed rearwardly from said vehicle wherein each of said camera units is configured to capture images of an associated one of a pair of blind spots with respect to said vehicle, each of said camera units being in wireless electrical communication with said electronic device wherein said electronic device is configured to display the images of the blind spots thereby facilitating the driver to safely change lanes.

2. The assembly according to claim 1, wherein each of said camera units comprises a housing having a first wall and a second wall, said second wall being concavely arcuate with respect to said first wall such that said housing has a bullet shape, said first wall being coupled to said distal end corresponding to an associated one of said handlebars.

3. The assembly according to claim 1, wherein each of said camera units comprises:
a housing being coupled to said distal end corresponding to an associated one of said handlebars; and
a camera being coupled to said second wall of said housing, said housing being oriented on said associated handlebar to point said camera rearwardly with respect to said vehicle wherein said camera is configured to capture the images of the associated blind spot, said camera being electrically coupled to said vehicle.

4. The assembly according to claim 3, further comprising a transmitter being coupled to said housing, said transmitter being electrically coupled to said vehicle, said transmitter being electrically coupled to said camera wherein said transmitter is configured to receive the images.

5. The assembly according to claim 4, wherein:
said electronic device includes a transceiver and a display; and
said transmitter is in electrical communication with said transceiver wherein said transceiver is configured to receive the images thereby facilitating said display to display the images.

6. A motorcycle camera system comprising:
a vehicle being configured to be ridden, said vehicle having a pair of handlebars, each of said handlebars having a distal end with respect to said vehicle;
an electronic device having a display and a transceiver;
a retaining unit being removably coupled to said handlebars, said retaining unit releasably engaging said electronic device such that said display is visible to a driver; and
a pair of camera units, each of said camera units being coupled to said vehicle, each of said camera units being directed rearwardly from said vehicle wherein each of said camera units is configured to capture images of an associated one of a pair of blind spots with respect to said vehicle, each of said camera units being in wireless electrical communication with said electronic device wherein said electronic device is configured to display the images of the blind spots thereby facilitating the driver to safely change lanes, each of said camera units comprising:
a housing having a first wall and a second wall, said second wall being concavely arcuate with respect to said first wall such that said housing has a bullet shape, said first wall being coupled to said distal end corresponding to an associated one of said handlebars,
a camera being coupled to said second wall of said housing, said housing being oriented on said associated handlebar to point said camera rearwardly with respect to said vehicle wherein said camera is configured to capture the images of the associated blind spot, said camera being electrically coupled to said vehicle, and
a transmitter being coupled to said housing, said transmitter being electrically coupled to said vehicle, said transmitter being electrically coupled to said camera wherein said transmitter is configured to receive the images, said transmitter being in electrical communication with said transceiver wherein said transceiver is configured to receive the images thereby facilitating said display to display the images.
